(19) United States
(12) Patent Application Publication
(10) Pub. No.: US 2014/0125885 A1
(43) Pub. Date: May 8, 2014

(54) TOUCH PANEL AND METHOD FOR MANUFACTURING THE SAME

(71) Applicant: SAMSUNG ELECTRO-MECHANICS CO., LTD., Suwon (KR)

(72) Inventors: Jung Eun Noh, Suwon (KR); Seung Heon Han, Suwon (KR); Hee Soo Kim, Suwon (KR); Jung Tae Park, Suwon (KR); Sung Yeol Park, Suwon (KR)

(73) Assignee: SAMSUNG ELECTRO-MECHANICS CO., LTD., Suwon (KR)

(21) Appl. No.: 14/074,583

(22) Filed: Nov. 7, 2013

(30) Foreign Application Priority Data
Nov. 8, 2012 (KR) 10-2012-0125880

(51) Int. Cl. G06F 1/16

(52) U.S. Cl. CPC G06F 1/1692
USPC 349/12; 430/312

(57) ABSTRACT

Disclosed herein are a touch panel and a method for manufacturing the same, the touch panel including: a transparent substrate; a black matrix pattern provided on an upper surface of the transparent substrate, the black matrix pattern having a plurality of openings; first electrode patterns provided on the black matrix pattern; and second electrode patterns provided on a lower surface of the transparent substrate, so that the touch panel includes the first electrode patterns formed of a silver salt, over the black matrix pattern having the plurality of openings, and thus can prevent a moiré phenomenon due to a metal material and improve visibility.

### CROSS REFERENCE TO RELATED APPLICATION

This application claims the benefit of Korean Patent Application No. 10-2012-0125880, filed on Nov. 8, 2012, entitled “Touch Panel and Method for Manufacturing the Same”, which is hereby incorporated by reference in its entirety into this application.

### BACKGROUND OF THE INVENTION

1. Technical Field

The present invention relates to a touch panel and a method for manufacturing the same.

2. Description of the Related Art

With the growth of computers using digital technology, devices assisting the computers have also been developed, and personal computers, portable transmitters and other personal information processors execute processing of text and graphic using a variety of input devices such as a keyboard, a mouse and so on.

While the rapid advancement of an information-oriented society has been widening the use of computers more and more, products may not be effectively operated by using only the keyboard and mouse that are currently responsible for the input device function. Therefore, there is an increasing need for a device that is simple, has minimum malfunction, and is capable of easily inputting information.

In addition, current techniques for input devices exceed the level of fulfilling general functions and thus are progressing toward techniques related to high reliability, durability, innovation, designing, and manufacturing. For achieving this, a touch panel has been developed as an input device capable of inputting information such as text and graphic, etc.

The touch panel is mounted on a display surface of an image display device such as an electronic organizer, a flat panel display including a liquid crystal display (LCD), a plasma display panel (PDP), an electroluminescence (El) device, or the like, or a cathode ray tube (CRT), so that a user selects desired information while viewing the image display device.

Meanwhile, the types of the touch panels are classified into a resistive type, a capacitive type, an electromagnetic type, a surface acoustic wave (SAW) type, and an infrared type. These various types of touch panels are adopted for electronic products in consideration of signal amplification problems, resolution difference, level of difficulty of designing and processing technologies, optical characteristics, electrical characteristics, mechanical characteristics, environment-resistant characteristics, input characteristics, durability, and economic efficiency. Currently, a resistive type panel and a capacitive to type touch panel have been used in a wide range of fields.

In these touch panels, an electrode pattern is generally formed of indium tin oxide (ITO). However, in respect to ITO, electrical conductivity thereof is low, and indium, which is a raw material thereof, is an expensive rare earth metal and is expected to be depleted within the next decade, and thus it may not be continuously supplied. Moreover, the electrode pattern formed of ITO easily incurs brittle fractures, and thus durability thereof may be deteriorated.

For this reason, studies on forming electrode patterns by using metal are actively progressing, as described in the patent document below.

As such, in the case where the electrode pattern is formed of metal, excellent electrical conductivity and continuous supply of a metal may be attained. However, when the electrode pattern is formed of metal, the electrode pattern needs to be formed with a mesh structure in order to prevent a user from visually recognizing the patterns.

However, when electrode patterns of a touch panel are formed with a mesh structure having a regular and predetermined distance, periodic characteristics between the electrode patterns of the touch panel overlap each other, and thus a moiré phenomenon may occur and visibility may be deteriorated.

### PRIOR ART DOCUMENT

### Patent Document

(Patent Document 1) US Patent Laid-Open Publication No. 20110291966 (laid-open published on Dec. 1, 2011)

### SUMMARY OF THE INVENTION

The present invention has been made in an effort to provide a touch panel including an electrode pattern formed of a silver salt and a black matrix.

The present invention has been also made in an effort to provide a method for manufacturing a touch panel including an electrode pattern formed of a silver salt and a black matrix.

According to one preferred embodiment of the present invention, there is provided a touch panel, including: a transparent substrate; a black matrix pattern provided on an upper surface of the transparent substrate, the black matrix pattern having a plurality of openings; first electrode patterns provided on the black matrix pattern; and second electrode patterns provided on a lower surface of the transparent substrate.

The touch panel may further include a plurality of color filters provided in the openings.

The black matrix pattern may be formed in black, by using any one or a combination of a carbon based material (graphene oxide, diamond line carbon (DLC)), chrome based oxide (CrO or CrO₂), copper based oxide (CuO), manganese based oxide (MnO₂), cobalt based oxide (CoO), sulfide (CoS₂, Co₃S₄), nickel based oxide (Ni₂O₃), HgTe, YBa₂Cu₃O₇, MoS₂, RuO₂, PdO, InP, SnO, TaN, and TaS₂.

The first electrode patterns and the second electrode patterns may be formed of patterns formed by exposing and developing a silver salt emulsion layer and containing silver.

The touch panel may further include: another transparent substrate provided between the first electrode patterns and the black matrix pattern; and a transparent electrode pattern for being electrically connected to the color filters, formed on a lower surface of another transparent substrate.

The transparent electrode pattern may be formed of metal oxide containing indium tin oxide (ITO).

According to another preferred embodiment of the present invention, there is provided a method for manufacturing a touch panel, the method including: (A) sequentially forming a black matrix layer and a first electrode layer on an upper surface of a transparent substrate; (B) forming a second electrode layer on a lower surface of the transparent substrate; (C) forming a dry film pattern on the upper surface of the first electrode layer, and then performing a patterning process using the dry film pattern, to form a plurality of first electrode patterns arranged in one direction and a black matrix pattern having a plurality of openings; (D) filing the openings with color filters; and (E) performing a patterning process using a dry film pattern on the second electrode layer to form a plurality of second electrode patterns being orthogonal to the arrangement direction of the first electrode patterns and exposing other openings overlapping the openings.

Here, in the stage (A), the black matrix layer may be formed in black, by using any one or a combination of a carbon based material (graphene oxide, diamond line carbon (DLC)), chrome based oxide (CrO or CrO₂), copper based oxide (CuO), manganese based oxide (MnO₂), cobalt based oxide (CoO), sulfide (CoS₂, Co₃S₄), nickel based oxide (Ni₂O₃), HgTe, YBa₂Cu₃O₇, MoS₂, RuO₂, PdO, InP, SnO, TaN, and TaS₂.

The first electrode layer and the second electrode layer may be formed of a silver salt emulsion layer using a slurry type where a silver salt and a binder are contained in a solvent.

According to still another preferred embodiment of the present invention, there is provided a method for manufacturing a touch panel, the method including: (I) forming an upper structure body including first electrode patterns and a transparent electrode pattern respectively provided on an upper surface and a lower surface of an upper transparent substrate; (II) forming a lower structure body including a black matrix pattern and second electrode patterns respectively provided on an upper surface and a lower surface of a lower transparent substrate; and (III) binding the upper structure body and the lower structure body to each other such that the transparent electrode pattern of the upper structure body correspond to the black matrix pattern of the lower structure body.

The stage (I) may include: (I-1) forming a first electrode layer made of a silver salt material on the upper surface of the upper transparent substrate; (I-2) forming a transparent electrode pattern made of a transparent conductive material on the lower surface of the upper transparent substrate; and (I-3) performing a patterning process using a dry film pattern on the first electrode layer to form a plurality of first electrode patterns arranged in one direction, from the first electrode layer.

The stage (II) may include: (II-1) forming a black matrix layer on the upper surface of the lower transparent substrate; (II-2) forming a second electrode layer made of a silver salt material on the lower surface of the lower transparent substrate; (II-3) performing a patterning process using a dry film pattern on the black matrix layer to form the black matrix pattern, the black matrix pattern having a plurality of openings; (II-4) providing color filters in the openings; and (II-5) performing a patterning process using a dry film pattern on the second electrode layer to form second electrode patterns, the second electrode patterns being arranged in an orthogonal direction to the arrangement direction of the first electrode patterns and being formed in a plurality of line shapes exposing other openings overlapping the openings.

Here, in the stage (III), the upper structure body and the lower structure body may be allowed to bind to each other such that the openings of the first electrode patterns overlap the openings of the black matrix pattern.

The black matrix pattern may be formed in black, by using any one or a combination of a carbon based material (graphene oxide, diamond line carbon (DLC)), chrome based oxide (CrO or CrO₂), copper based oxide (CuO), manganese based oxide (MnO₂), cobalt based oxide (CoO), sulfide (CoS₂, Co₃S₄), nickel based oxide (Ni₂O₃), HgTe, YBa₂Cu₃O₇, MoS₂, RuO₂, PdO, InP, SnO, TaN, and TaS₂.

The transparent electrode pattern may be formed of metal oxide containing indium tin oxide (ITO).

### BRIEF DESCRIPTION OF THE DRAWINGS

The above and other objects, features and advantages of the present invention will be more clearly understood from the following detailed description taken in conjunction with the accompanying drawings, in which:

FIG. 1A is a top view of a touch panel according to a preferred embodiment of the present invention;

FIG. 1B is a bottom view of the touch panel according to the preferred embodiment of the present invention;

FIG. 2 is a cross-sectional view taken along the line I-I′ of FIG. 1A;

FIG. 3 is a cross-sectional view of a touch panel according to another preferred embodiment of the present invention;

FIGS. 4A to 4C are cross-sectional views showing processes of a method for manufacturing the touch panel according to a preferred embodiment of the present invention; and

FIGS. 5A to 5D are cross-sectional views showing processes of a method for manufacturing the touch panel according to another preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

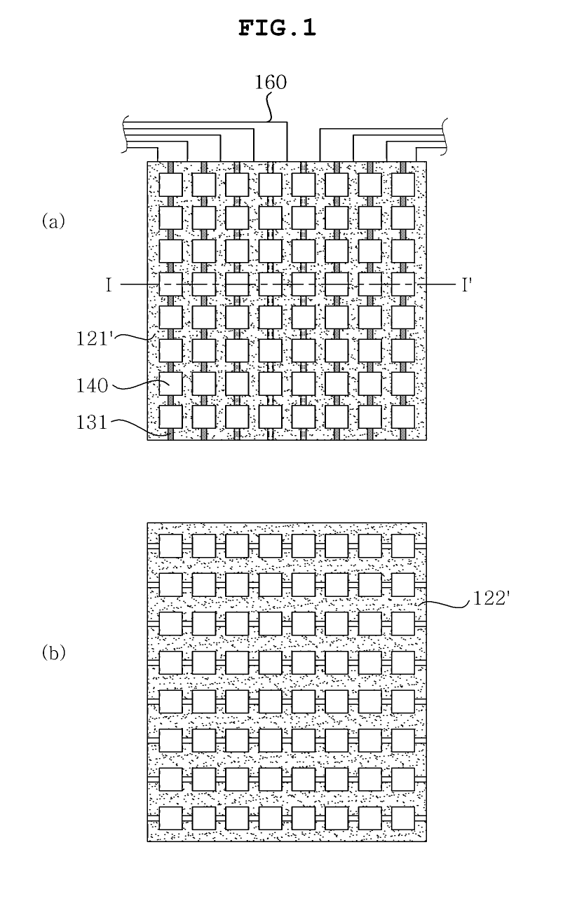

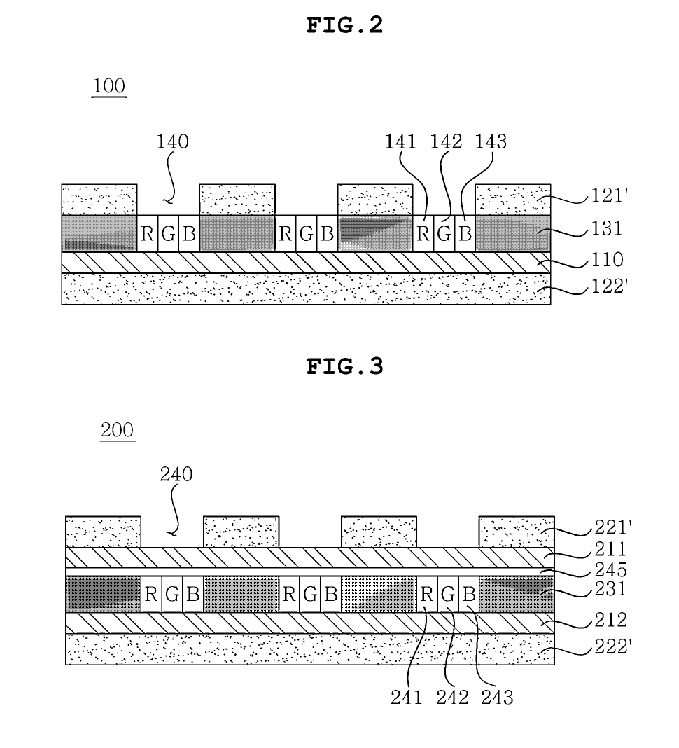

Hereinafter, preferred embodiments of the present invention will be described in detail with reference to the accompanying drawings. FIG. 1A is a top view of a touch panel according to one preferred embodiment of the present invention; FIG. 1B is a bottom view of the touch panel according to the preferred embodiment of the present invention; and FIG. 2 is a cross-sectional view taken along the line I-I′ of FIG. 1A.

A touch panel 100 according to one preferred embodiment of the present invention may include: a transparent substrate 110; a black matrix pattern 131 provided on an upper surface of the substrate 110, the black matrix pattern 131 having a plurality of openings 140; first electrode patterns 121′ provided on the black matrix pattern 131; and second electrode patterns 122′ provided on a lower surface of the transparent substrate 110.

The transparent substrate 110 is divided into an active area and a bezel area. In the active area, the black matrix pattern 131, the first electrode patterns 121′, and the second electrode patterns 122′ are formed so that a touch by an input unit is recognizable. The active area is defined at a center of the transparent substrate 110. In the bezel area, first electrode wirings 160 connected to the first electrode patterns 121′ and second electrode wirings (not shown) connected to the second electrode patterns 122′ are formed. The bezel area is defined at an edge portion of the active area.

Here, the transparent substrate 110 needs to have bearing force to bear the black matrix pattern 131, the first electrode patterns 121′, and the second electrode patterns 122′, and transparency to allow a user to recognize an image provided by an image display device.

In consideration of the bearing force and transparency, the transparent substrate 110 may preferably be formed of polyethyleneterephthalate (PET), polycarbonate (PC), polymethylmethacrylate (PMMA), polyethylenenaphthalate (PEN), polyethersulfone (PES), cyclic olefin copolymer (COC), a triacetylcellulose (TAC) film, a polyvinyl alcohol (PVA) film, a polyimide (PI) film, polystyrene (PS), biaxially oriented polystyrene (BOPS; containing K resin), glass or reinforced glass, or the like, but is not particularly limited thereto.

The black matrix pattern 131 has a plurality of openings 140 on the upper surface of the transparent substrate 110. A red (R) color filter 141, a green (G) color filter 142, and a blue (B) color filter 143 are provided in each of the openings 140.

The black matrix pattern 131 may be formed in black, by using a carbon based material (graphene oxide, diamond line carbon (DLC)), chrome based oxide (CrO or CrO₂), copper based oxide (CuO), manganese based oxide (MnO₂), cobalt based oxide (CoO), sulfide (CoS₂, Co₃S₄), nickel based oxide (Ni₂O₃), HgTe, YBa₂Cu₃O₇, MoS₂, RuO₂, PdO, InP, SnO, TaN, TaS₂, or the like.

This black matrix pattern 131 has the plurality of openings 140 in which the color filters 141, 142, and 143 are provided. The black matrix serves to prevent interference of light between neighboring openings 140 in which the color filters 141, 142, and 143 are provided and block external light.

This black matrix pattern 131 may have a conductive pattern (not shown) for being electrically connected to the color filters 141, 142, and 143 therein.

The first electrode patterns 121′ are arranged in one direction on the black matrix pattern 131, and are formed in a plurality of line shapes exposing the openings 140, as shown in FIG. 1A. The first electrode pattern 121′ may be formed by exposing and developing, for example, a silver salt emulsion layer.

Here, the silver salt emulsion layer may use a slurry type where a silver salt and a binder are contained in a solvent, and may further contain additives such as a dye and the like.

Specifically, as the silver salt, an inorganic silver salt such as silver halide and an organic silver salt such as silver acetate may be used, and as the binder, for example, gelatin, polyvinyl alcohol (PVA), polyvinyl pyrrolidone (PVP), polysaccharide such as starch, cellulose or its derivative, polyethylene oxide, polyvinyl amine, chitosan, poly-lysine, polyacrylic acid, poly alginic acid, poly hyaluronic acid, carboxy cellulose, or the like may be used.

There is no particular limitation on the solvent, but, as the solvent, for example, water, an organic solvent (e.g., alcohols such as methanol and the like, ketones such as acetone and the like, amides such as formamide and the like, sulfoxides such as dimethyl sulfoxide and the like, esters such as ethyl acetate and the like, ethers, or the like), an ionic liquid, and a mixture solvent thereof may be used. There are no particular limitations on other additives, but the known additives may be preferably used.

The first electrode pattern 121′ may have a sheet resistance of, for example, 0.1 to 10Ω/□. Here, the reason that the sheet resistance of the first electrode pattern 121′ is 0.1 to 10Ω/□ is that, if the sheet resistance of the first electrode pattern 121′ is below 0.1Ω/□, the amount of silver salt is too much, resulting in deteriorating transparency, and if the sheet resist of the first electrode pattern 121′ is above 10Ω/□, electric conductivity may be low, resulting in decreasing utility thereof as an electrode.

The second electrode patterns 122′ are arranged in an orthogonal direction to the arrangement direction of the first electrode patterns 121′ on a lower surface of the transparent substrate 110 and are formed in a plurality of line shapes exposing other openings (not shown) overlapping the openings 140, as shown in FIG. 1B and FIG. 2.

The second electrode pattern 122′ may be formed by exposing and developing a silver salt emulsion layer like the first electrode pattern 121′, and may have a sheet resistance of 0.1 to 10Ω/□.

In addition, the first electrode patterns 121′ and the second electrode patterns 122′ are extended to the first electrode wirings 160 and the second electrode wirings (not shown) for transmitting electric signals in the bezel area.

The touch panel 100 according to the preferred embodiment of the present invention includes the first electrode patterns 121′ formed of a silver salt, over the black matrix pattern 131 having the plurality of openings 140, and thus can prevent a moiré phenomenon due to a metal material in the prior art and improve visibility.

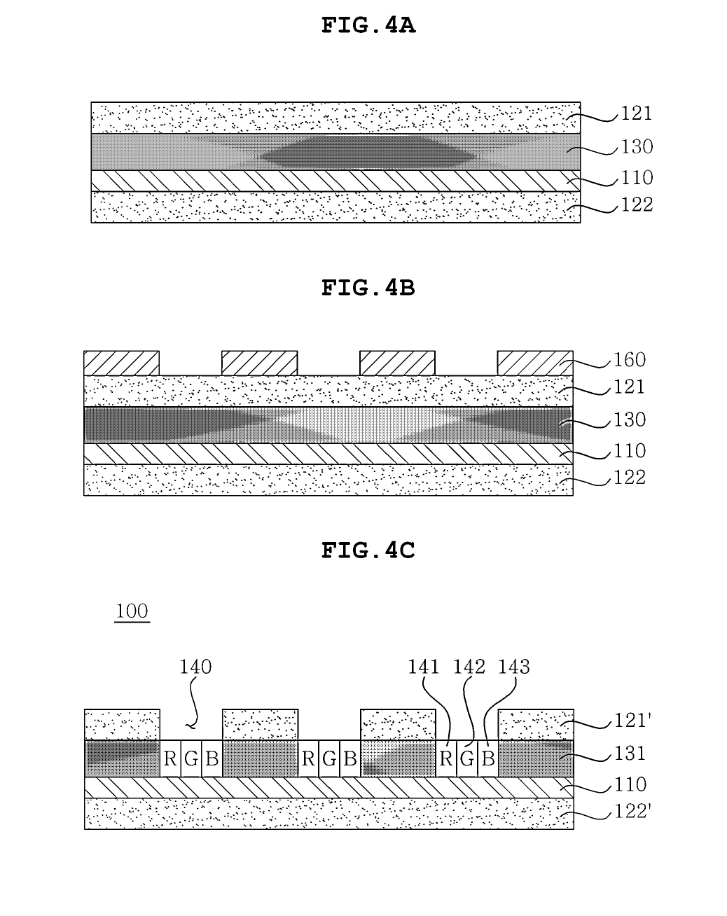

Here, a touch panel according to another preferred embodiment of the present invention will be described with reference to FIG. 3. FIG. 3 is a cross-sectional view of the touch panel according to another preferred embodiment of the present invention.

A touch panel 200 according to another preferred embodiment of the present invention is realized with a structure where two transparent substrates 211 and 212 are provided and color filters 241, 242, and 243 and a black matrix pattern 231 are interposed between the two transparent substrates 211 and 212, unlike the touch panel 100 according to one preferred embodiment of the present invention. Therefore, descriptions of the touch panel 200 according to another preferred embodiment of the present invention, that overlap with those of the touch panel 100 according to one preferred embodiment of the present invention, will be omitted.

The touch panel 200 according to another preferred embodiment of the present invention may include: an upper transparent substrate 211; first electrode patterns 221′ having a plurality of openings 240 on an upper surface of the upper transparent substrate 211; color filters 241, 242, and 243 overlapping the openings 240 and a black matrix pattern 231 surrounding the color filters 241, 242, and 243, between the upper transparent substrate 211 and a lower transparent substrate 212; second electrode patterns 222′ provided on a lower surface of the lower transparent substrate 212; and a transparent electrode pattern 245 for being electrically connected to the color filters 241, 242, and 243 on a lower surface of the upper transparent substrate 211, as shown in FIG. 3.

The black matrix pattern 231 surrounding the color filters 241, 242, and 243 may be interposed between the upper transparent substrate 211 and the lower transparent substrate 212, and the transparent electrode 245 for being electrically connected to the color filters 241, 242, and 243 may be provided therebetween.

Here, the transparent electrode 245 may be formed of metal oxide such as indium tin oxide (ITO) or the like.

The first electrode patterns 221′ are arranged in one direction on the upper transparent substrate 211, and are formed in a plurality of line shapes exposing the openings 240 overlapping the color filters 241, 242, and 243, as shown in FIG. 3. The first electrode patterns 221′ may be formed by exposing and developing, for example, a silver salt emulsion layer.

The second electrode patterns 222′ are arranged in an orthogonal direction to the arrangement direction of the first electrode patterns 221′ on a lower surface of the lower transparent substrate 212 and are formed in a plurality of line shapes exposing other openings (not shown) overlapping the openings 240. The second electrode patterns 222′ may be formed by exposing and developing a silver salt emulsion layer, like the first electrode pattern 221′.

The black matrix pattern 231 may be formed in black, by using a carbon based material (graphene oxide, diamond line carbon (DLC)), chrome based oxide (CrO or CrO₂), copper based oxide (CuO), manganese based oxide (MnO₂), cobalt based oxide (CoO), sulfide (CoS₂, Co₃S₄), nickel based oxide (Ni₂O₃), HgTe, YBa₂Cu₃O₇, MoS₂, RuO₂, PdO, InP, SnO, TaN, TaS₂, or the like.

The touch panel 200 according to another preferred embodiment of the present invention includes the first electrode patterns 221′ and the second electrode patterns 222′, formed of a silver salt material, and include a black matrix pattern 231 between the first electrode patterns 221′ and the second electrode patterns 222′, and thus can prevent a moiré phenomenon due to the metal material in the prior art and improve visibility.

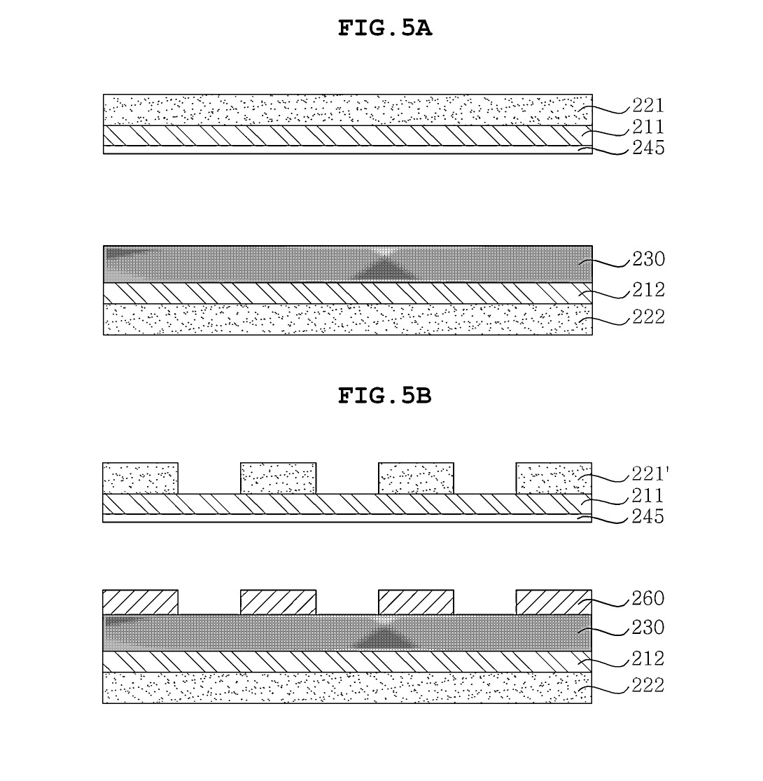

Hereafter, a method for manufacturing the touch panel 100 according to one preferred embodiment of the present invention will be described with reference to FIGS. 4A to 4C. FIGS. 4A to 4C are cross-sectional views showing processes of a method for manufacturing the touch panel according to one preferred embodiment of the present invention.

As shown in FIG. 4A, as for the method for manufacturing the touch panel 100 according to one preferred embodiment of the present invention, first, a black matrix layer 130 and a first electrode layer 121 are sequentially formed on an upper surface of a transparent substrate 110, and then a second electrode layer 122 is formed on a lower surface of the transparent substrate 110.

Specifically, the black matrix layer 130 may be formed by a deposition method such as CVD or PVD, or a coating method. The black matrix layer 130 may be formed in black, by using a carbon based material (graphene oxide, diamond line carbon (DLC)), chrome based oxide (CrO or CrO₂), copper based oxide (CuO), manganese based oxide (MnO₂), cobalt based oxide (CoO), sulfide (CoS₂, Co₃S₄), nickel based oxide (Ni₂O₃), HgTe, YBa₂Cu₃O₇, MoS₂, RuO₂, PdO, InP, SnO, TaN, TaS₂, or the like.

The first electrode layer 121 and the second electrode layer 122 may be formed of a silver salt emulsion layer by a coating method using a slurry where a silver salt and a binder are contained in a solvent.

Specifically, as the silver salt, an inorganic silver salt such as silver halide and an organic silver salt such as silver acetate may be used, and as the binder, for example, gelatin, polyvinyl alcohol (PVA), polyvinyl pyrrolidone (PVP), polysaccharide such as starch, cellulose or its derivative, polyethylene oxide, polyvinyl amine, chitosan, poly-lysine, polyacrylic acid, poly alginic acid, poly hyaluronic acid, carboxy cellulose, or the like may be used.

There is no particular limitation on the solvent, but, as the solvent, for example, water, an organic solvent (e.g., alcohols such as methanol and the like, ketones such as acetone and the like, amides such as formamide and the like, sulfoxides such as dimethyl sulfoxide and the like, esters such as ethyl acetate and the like, ethers, or the like), an ionic liquid, and a mixture solvent thereof may be used. There are no particular limitations on other additives, but the known additives may be preferably used.

As shown in FIG. 4B, after forming the first electrode layer 121 and the second electrode layer 122, a dry film pattern 160 for patterning the first electrode layer 121 is formed on an upper surface of the first electrode layer 121.

An exposure process and a development process using this dry film pattern 160 are performed, to form first electrode patterns 121′ and a black matrix pattern 131, having openings 140, as shown in FIG. 4C.

As such, the first electrode patterns 121′ and the black matrix pattern 131 are simultaneously formed with the openings 140, thereby preventing pattern alignment with respect to the openings 140.

Then, as shown in FIG. 4C, a red (R) color filter 141, a green (G) color filter 142, and a blue (B) color filter 143 are formed in each of the openings 140 by filling the each of the openings.

Separately from this procedure, a patterning process using a dry film pattern is performed on the second electrode layer 122, to form second electrode pattern 122′ which are arranged in an orthogonal direction to the arrangement direction of the first electrode patterns 121′ and are formed in a plurality of line shapes exposing other openings (not shown) overlapping the openings 140.

In the method for manufacturing the touch panel 100 according to one preferred embodiment of the present invention as above, the black matrix pattern 131 is interposed between the transparent substrate 110 and the first electrode patterns 121′ and the first electrode patterns 121′ and the second electrode patterns 122′ are formed of a silver salt, so that there can be provided a touch panel capable of preventing a moiré phenomenon due to a metal material in the prior art and improving visibility.

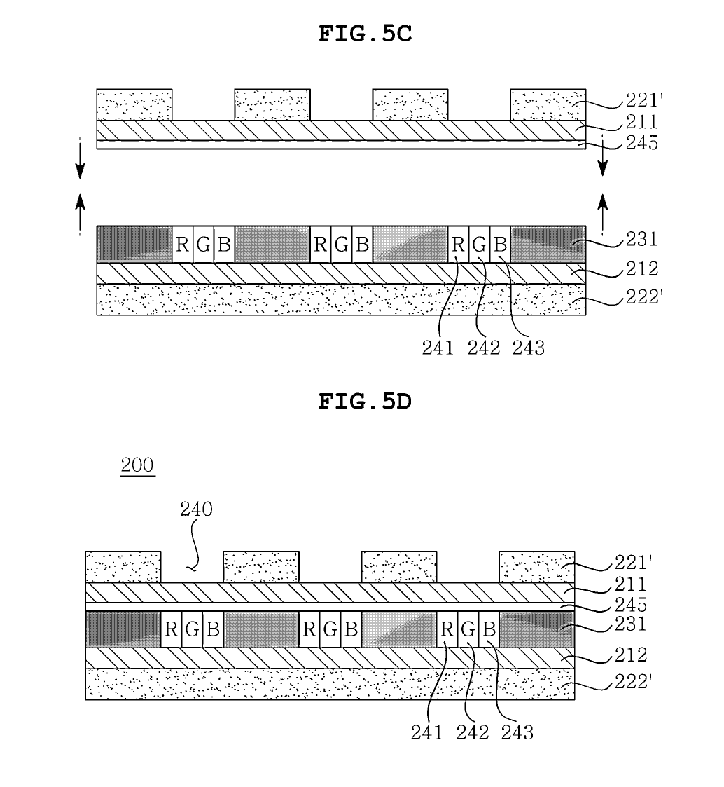

Hereinafter, a method for manufacturing the touch panel 200 according to another preferred embodiment of the present invention will be described with reference to FIGS. 5A to 5D. FIGS. 5A to 5D are cross-sectional views showing processes of a method for manufacturing the touch panel according to another embodiment of the present invention.

As shown in FIG. 5A, a method for manufacturing the touch panel 200 according to another preferred embodiment of the present invention is divided into a process for a structure body with respect to an upper transparent substrate 211 and a structure body with respect to a lower transparent substrate 212.

That is, a first electrode layer 221 made of a silver salt material and a transparent electrode pattern 245 made of a transparent conductive material are formed on an upper surface and a lower surface of the upper transparent substrate 211, respectively. A black matrix layer 230 and a second electrode layer 222 are formed on an upper surface and a lower surface of the lower transparent substrate 212.

Then, as shown in FIG. 5B, in the structure body with respect to the lower transparent substrate 212, a patterning process using a dry film pattern 260 is performed on the black matrix layer 230, to form a black matrix pattern 231 having openings for providing color filters 241, 242, and 243 therein.

Here, a patterning process using a dry film pattern is performed on the second electrode layer 222, to form second electrode pattern 222′ which are arranged in an orthogonal direction to the arrangement direction of the first electrode patterns 221′ and formed in a plurality of line shapes exposing other openings (not shown) overlapping the openings 240.

In addition, also in the structure body with respect to the upper transparent substrate 211, a patterning process using a dry film pattern (not shown) is performed on the first electrode layer 221, to form first electrode patterns 221′ from the first electrode layer 221.

After forming the structure body with respect to the upper transparent substrate 211 and the structure body with respect to the lower transparent substrate 212, color filters 241, 242, and 243 fill the opening of the black matrix pattern 231, as shown in FIG. 5C.

Then, as shown in FIG. 5C, the structure body with respect to the upper transparent substrate 211 and the structure body with respect to the lower transparent substrate 212 are allowed to bind to each other such that the color filters 241, 242, and 243 are correspondingly joined to the transparent electrode pattern 245. Here, thermal pressing may be applied in order to allow the structure body with respect to the upper transparent substrate 211 and the structure body with respect to the lower transparent substrate 212 to bind to each other.

For this reason, as shown in FIG. 5D, a structure can be obtained where the first electrode patterns 221′ having the openings 240 overlapping the color filters 241, 242, and 243 and the second electrode patterns 222′ are formed of a silver salt material and the black matrix pattern 231 is interposed between the first electrode patterns 221′ and the second electrode patterns 222′, that is, between the upper transparent substrate and the lower transparent substrate 212.

Therefore, through the method for manufacturing the touch panel 200 according to another preferred embodiment of the present invention, there can be provided a touch panel capable of solving sparkling and preventing a moiré phenomenon due to a metal material and improving visibility in a touch panel structure including two transparent substrates such as the upper transparent substrate 211 and the lower transparent substrate 212.

As set forth above, the touch panel according to the present invention includes first electrode patterns formed of a silver salt, over the black matrix pattern having the plurality of openings, and thus can prevent a moiré phenomenon due to a metal material in the prior art and improve visibility.

In the method for manufacturing the touch panel according to the present invention, the black matrix pattern is interposed between the transparent substrate and the first electrode patterns, and the first electrode patterns and the second electrode patterns are formed of a silver salt, and thus, there can be provided a touch panel capable of preventing a moiré phenomenon due to a metal material in the prior art and improving visibility.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A touch panel, comprising:
a transparent substrate;
a black matrix pattern provided on an upper surface of the transparent substrate, the black matrix pattern having a plurality of openings;
first electrode patterns provided on the black matrix pattern; and
second electrode patterns provided on a lower surface of the transparent substrate.

2. The touch panel as set forth in claim 1, further comprising a plurality of color filters provided in the openings.

3. The touch panel as set forth in claim 1, wherein the black matrix pattern is formed in black, by using any one or a combination of a carbon based material (graphene oxide, diamond line carbon (DLC)), chrome based oxide (CrO or CrO₂), copper based oxide (CuO), manganese based oxide (MnO₂), cobalt based oxide (CoO), sulfide (CoS₂, Co₃S₄), nickel based oxide (Ni₂O₃), HgTe, YBa₂Cu₃O₇, MoS₂, RuO₂, PdO, InP, SnO, TaN, and TaS₂.

4. The touch panel as set forth in claim 1, wherein the first electrode patterns and the second electrode patterns are formed of patterns formed by exposing and developing a silver salt emulsion layer and containing silver.

5. The touch panel as set forth in claim 2, further comprising:
another transparent substrate provided between the first electrode patterns and the black matrix pattern; and
a transparent electrode pattern for being electrically connected to the color filters, formed on a lower surface of another transparent substrate.

6. The touch panel as set forth in claim 5, wherein the transparent electrode pattern is formed of metal oxide containing indium tin oxide (ITO).

7. A method for manufacturing a touch panel, the method comprising:
(A) sequentially forming a black matrix layer and a first electrode layer on an upper surface of a transparent substrate;
(B) forming a second electrode layer on a lower surface of the transparent substrate;
(C) forming a dry film pattern on the upper surface of the first electrode layer, and then performing a patterning process using the dry film pattern, to form a plurality of first electrode patterns arranged in one direction and a black matrix pattern having a plurality of openings;
(D) filing the openings with color filters; and
(E) performing a patterning process using a dry film pattern on the second electrode layer to form a plurality of second electrode patterns being orthogonal to the arrangement direction of the first electrode patterns and exposing other openings overlapping the openings.

8. The method as set forth in claim 7, wherein in the stage (A), the black matrix layer is formed in black, by using any one or a combination of a carbon based material (graphene oxide, diamond line carbon (DLC)), chrome based oxide (CrO or CrO₂), copper based oxide (CuO), manganese based oxide (MnO₂), cobalt based oxide (CoO), sulfide (CoS₂, Co₃S₄), nickel based oxide (Ni₂O₃), HgTe, YBa₂Cu₃O₇, MoS₂, RuO₂, PdO, InP, SnO, TaN, and TaS₂.

9. The method as set forth in claim 7, wherein the first electrode layer and the second electrode layer are formed of a silver salt emulsion layer using a slurry type where a silver salt and a binder are contained in a solvent.

10. A method for manufacturing a touch panel, the method comprising:
(I) forming an upper structure body including first electrode patterns and a transparent electrode pattern respectively provided on an upper surface and a lower surface of an upper transparent substrate;
(II) forming a lower structure body including a black matrix pattern and second electrode patterns respectively provided on an upper surface and a lower surface of a lower transparent substrate; and
(III) binding the upper structure body and the lower structure body to each other such that the transparent electrode pattern of the upper structure body correspond to the black matrix pattern of the lower structure body.

11. The method as set forth in claim 10, wherein the stage (I) includes:
(I-1) forming a first electrode layer made of a silver salt material on the upper surface of the upper transparent substrate;
(I-2) forming a transparent electrode pattern made of a transparent conductive material on the lower surface of the upper transparent substrate; and
(I-3) performing a patterning process using a dry film pattern on the first electrode layer to form a plurality of first electrode patterns arranged in one direction, from the first electrode layer.

12. The method as set forth in claim 10, wherein the stage (II) includes:
(II-1) forming a black matrix layer on the upper surface of the lower transparent substrate;
(II-2) forming a second electrode layer made of a silver salt material on the lower surface of the lower transparent substrate;
(II-3) performing a patterning process using a dry film pattern on the black matrix layer to form the black matrix pattern, the black matrix pattern having a plurality of openings;
(II-4) providing color filters in the openings; and
(II-5) performing a patterning process using a dry film pattern on the second electrode layer to form second electrode patterns, the second electrode patterns being arranged in an orthogonal direction to the arrangement direction of the first electrode patterns and being formed in a plurality of line shapes exposing other openings overlapping the openings.

13. The method as set forth in claim 12, wherein in the stage (III), the upper structure body and the lower structure body are allowed to bind to each other such that the openings of the first electrode patterns overlap the openings of the black matrix pattern.

14. The method as set forth in claim 12, wherein the black matrix pattern is formed in black, by using any one or a combination of a carbon based material (graphene oxide, diamond line carbon (DLC)), chrome based oxide (CrO or CrO₂), copper based oxide (CuO), manganese based oxide (MnO₂), cobalt based oxide (CoO), sulfide (CoS₂, Co₃S₄), nickel based oxide (Ni₂O₃), HgTe, YBa₂Cu₃O₇, MoS₂, RuO₂, PdO, InP, SnO, TaN, and TaS₂.

15. The method as set forth in claim 11, wherein the transparent electrode pattern is formed of metal oxide containing indium tin oxide (ITO).
